(19) United States
(12) Patent Application Publication
(10) Pub. No.: US 2009/0047048 A1
(43) Pub. Date: Feb. 19, 2009

(54) PRESSURE ROLLER AND METHOD FOR PRODUCTION THEREOF

(75) Inventors: Yoshitaka Ikeda, Osaka (JP); Kazuhiro Kizawa, Osaka (JP)

Correspondence Address: OSHA LIANG L.L.P., TWO HOUSTON CENTER, 909 FANNIN, SUITE 3500, HOUSTON, TX, 77010, US

(73) Assignee: SUMITOMO ELECTRIC FINE POLYMER, INC., Sennan-gun, Osaka (JP)

(21) Appl. No.: 12/067,279

(22) PCT Filed: Oct. 19, 2006
(86) PCT No.: PCT/JP2006/321312

§ 371 Date: Mar. 18, 2008

(51) Int. Cl. G03G 15/20

(52) U.S. Cl. 399/333

(57) ABSTRACT

A pressure roller includes a rubber layer containing organic microballoons and a heat-resistant resin layer arranged in that order on a roller base, wherein an intermediate rubber layer having a heat conductivity of 1.0 to 4.0 W/m·K is arranged between the rubber layer containing the organic microballoons and the heat-resistant resin layer. There is provided a method for producing the pressure roller.

### TECHNICAL FIELD

The present invention relates to pressure roller s used in fixing units of image-forming apparatuses utilizing electrophotographic method. Specifically, the present invention relates to a pressure roller opposite a fixing roller or a fixing belt in a fixing unit for heating and pressurizing a toner image formed on a transfer material such as paper to fix the toner image on the transfer material.

### BACKGROUND ART

In image-forming apparatuses, such as copiers, facsimiles, and laser-beam printers, utilizing electrophotographic methods (including electrostatic recording methods), an image is generally formed by a series of steps: a charging step of uniformly charging a photoconductive drum, an exposure step of performing image exposure to form an electrostatic latent image on the photoconductive drum, a development step of attaching toner (developing powder) to the electrostatic latent image to form a toner image (visible image), a transfer step of transferring the toner image on the photoconductive drum to a transfer material such as paper or an overhead transparency film, and a fixing step of fixing the unfixed toner image on the transfer material.

In the fixing step, the toner image on the transfer material is generally fixed by any of various methods, such as heating, pressurization, and solvent vapor. In image-forming apparatuses such as electrophotographic copiers, fixation is generally performed by heating and pressurization. Toner used as a developing powder is composed of a colored resin powder containing a coloring and other additives in a binder resin. Toner is broadly categorized into toner made by a grinding and toner made by polymerization on the basis of production processes. Heating and pressurizing toner to a temperature equal to or higher than the melting point or softening temperature of a binder resin results in melting or softening the toner to fuse the toner on a transfer material.

For example, as shown in FIG. 5 that is a cross-sectional view, heating and pressurizing fixing unit includes a cylindrical fixing roller 501 and a pressure roller 506. A transfer material 504 having an unfixed toner image 503 is passed into a nip between both rollers to heat and pressurize the unfixed toner. The fixing roller 501 includes a heating means 502 such as an electric heater therein and controls the surface temperature of the fixing roller with the heating means. The unfixed toner image 503 is heated and pressurized between both rollers to be fused, thereby forming a fixed toner image 505 on the transfer material 504.

For example, the fixing roller 501 has a structure in which a fluororesin layer is formed on the surface of a cylindrical cored bar with, if necessary, a thin rubber layer. In a fixing method shown in FIG. 5, the surface temperature of the fixing roller 501 is increased to a predetermined temperature with the heating means 502 arranged in the hollow interior of the fixing roller 501. In this fixing method, it takes time to increase the surface temperature of the fixing roller 501 to a fixing temperature. Thus, a relatively long waiting period is required before the image-forming apparatus is operational after power-on.

In contrast, as shown in FIG. 6 that is a cross-sectional view, in a fixing unit including a heating means 602 such as an electric heater opposite a pressure roller 606 via a thin fixing belt 601, an unfixed toner image 603 on a transfer material 604 is substantially directly heated with the heating means 602, thus reducing the waiting period after power-on. The fixing belt 601 and the pressure roller 606 rotate in the opposite direction to each other. The heating means 602 is arranged at a predetermined position so as to face the pressure roller 606. The unfixed toner image 603 passing through the fixing unit is fused on the transfer material 604 to form a fixed image 605. As the fixing belt, a fixing belt having a structure in which a fluororesin layer is arranged on a surface of an endless belt base, such as a heat-resistant resin tube or a metal tube, via a thin rubber layer if necessary is used.

In the fixing unit, the pressure roller arranged opposite the fixing roller or the fixing belt is required to have an excellent mold-releasing property, heat resistance, surface roughness, durability, and the like and have moderate elasticity. Hitherto, therefore, a pressure roller having the following structure has been widely used: a roller base formed of a columnar or cylindrical cored bar, a relatively thick rubber layer, and a thin heat-resistant resin layer having excellent mold-releasing property and heat resistance, the rubber layer being arranged on the base, and the resin layer being arranged on the rubber layer. As the heat-resistant resin, a fluororesin has been widely used. The pressure roller with such a structure has moderate elasticity imparted by the rubber layer and the mold-releasing property imparted by the heat-resistant resin layer.

In recent years, demands for higher energy efficiency, a full-color image, and higher speed printing have been increasing.

To achieve higher energy efficiency, electric power required for heating with the fixing unit needs to be reduced. Furthermore, to achieve higher energy efficiency, heating efficiency of the fixing unit needs to be improved.

To provide full-color images, color toners, such as Cyan, Magenta, and Yellow toners, are used. Development is sequentially performed with the color toners. In the transfer step, the resulting color toner images are transferred to the transfer material so as to be sequentially stacked. In the fixing step, to obtain a clear color image, preferably, an unfixed toner image having a thickness larger than that of a monochrome toner image is heated and pressurized to be sharply melt. A full-color image can be sufficiently obtained by improving the heating efficiency of the fixing unit.

To achieve higher speed printing, in the fixing unit, it is necessary to pass a transfer material having an unfixed toner at a high speed to efficiently melt the unfixed toner. Higher speed printing can also be achieved by improving heating efficiency in the fixing unit.

To meet the above-described demands, in the technical field of toner, toner that can be fixed at a temperature lower than fixing temperatures in the related art is currently being developed. To reduce the fixing temperature of the toner, however, a binder resin needs to have a low glass transition temperature or a low softening temperature, thereby allowing toner particles to aggregate and easily degrade flowability. The degradation of the flowability of the toner results in insufficient development. Thus, it is very difficult to strike a balance between anti-aggregation properties and low-temperature-fixing properties.

To meet the above-described demands, in the technical field of image-forming apparatuses, fixing rollers or fixing belts having excellent thermal conductivity are currently being developed (for example, Japanese Unexamined Patent Application Publication Nos. 7-110632, 10-10893, and 10-198201). An increase in the thermal conductivity of a fixing roller or a fixing belt results in the fixation of an unfixed toner image on a transfer material with high heat efficiency.

With respect to a pressure roller arranged opposite the fixing roller and the fixing belt a method for improving elasticity and flexibility is proposed. By improving the elasticity and flexibility of the pressure roller, an unfixed toner image on a transfer material can be heated and pressurized while being covered with the nip between the pressure roller and the fixing roller or the fixing belt, thus increasing the printing speed and sharply melting the color toner image.

To improve the elasticity and flexibility of the press roller, for example, the following methods are reported: a method of arranging a foamed rubber layer between a roller base formed of a cored bar and a heat-resistant resin layer (outermost layer) having mold-releasing properties (e.g., Japanese Unexamined Patent Application Publication No. 12-108223), and a method of arranging a rubber layer containing organic microballoons (e.g., Japanese Unexamined Patent Application Publication Nos. 2000-230541 and 2001-295830).

In particular, according to the method of arranging the rubber layer containing organic microballoons between a roller base and a heat-resistant resin layer, a flexible pressure roller having uniform hardness, excellent elasticity, interlayer adhesion, heat resistance, mold-releasing properties, surface smoothness, durability, and improved adiabaticity can be obtained, compared with those of a pressure roller obtained by the method of arranging the foamed rubber layer.

FIG. 4 is a cross-sectional view of a pressure roller having the above-described structure. The pressure roller has a layer configuration in which a rubber layer 2 containing organic microballoons and a heat-resistant resin layer 3 are arranged in that order on a roller base 1.

Japanese Unexamined Patent Application Publication Nos. 2000-230541 and 2001-295830 each disclose that if the pressure roller draws heat from a transfer material, toner on the transfer material is insufficiently melted to degrade fixation and that thus the pressure roller preferably has excellent adiabaticity. Specifically, Japanese Unexamined Patent Application Publication No. 2000-230541 discloses that the rubber layer containing the organic microballoons preferably has a heat conductivity of 0.5×10⁻³ cal/cm·s·° C. [=0.2 W/m·K) or less.

Japanese Unexamined Patent Application Publication No. 2001-295830 discloses that the rubber layer containing the organic microballoons preferably has a heat conductivity of 1×10⁻⁵ cal/cm·s·° C. [=0.4 W/m·K] or less. In each of EXAMPLES 1 to 9, a pressure roller with a rubber layer containing organic microballoons and having a heat conductivity of 3.0×10⁻⁴ cal/cm·s·° C. [=0.13 W/m·K] to 4.0×10⁻⁴ cal/cm·s·° C. [=0.13 W/m·K] is described. Heat-resistant resin layers (outermost layers) such as fluororesin layers described in these patent documents each have a heat conductivity as low as 0.2 W/m·K or less.

In this way, the use of the pressure roller including the heat-resistant resin layer and the rubber layer having low heat conductivity and excellent adiabaticity is considered to prevent the transfer of heat from the fixing roller or the fixing belt to the pressure roller, thereby efficiently heating an unfixed toner image on a transfer material.

In image-forming apparatuses such as electrophotographic copiers (hereinafter, also referred to as “printers”), low-speed models in which the number of sheets printed per minute is four (printing speed=4 sheets/min) are being switched to, for example, middle-speed models in which the number of sheets printed per minute is 12 (printing speed=12 sheets/min) or 16 (printing speed=16 sheets/min). Hitherto, such middle printing speeds have been defined as “high printing speeds”. Currently, high-speed models in which the number of sheets printed per minute is, for example, 30 sheets (printing speed=30 sheets/min) or 35 (printing speed=35 sheets/min) are developed. It is predicted that in the future, printers having printing speeds exceeding these printing speeds will be developed.

The results of the study by the inventors demonstrated the following: although pressure roller having the rubber layer containing the organic microballoons arranged between the roller base and the heat-resistant resin layer has excellent properties as described above, the use of the pressure roller in a fixing unit for a printer having a high printing speed is liable to disadvantageously cause degradation of fixation and the occurrence of offset. In full-color printing, it is particularly difficult to sharply melt an unfixed thick toner image formed by laminating different color toners under such high-speed printing conditions.

Such disadvantageous phenomena suggest that a fixing unit including a known pressure roller has insufficient heating efficiency.

### DISCLOSURE OF INVENTION

It is an object of the present invention to provide a pressure roller used in a fixing unit of an image-forming apparatus utilizing an electrophotographic method, the pressure roller having a flexible rubber layer with uniform hardness and having excellent flexibility, interlayer adhesion, heat resistance, mold-releasing properties, surface smoothness, durability, and high heating efficiency, and the pressure roller being sufficiently usable in high-speed printing and full-color printing as well as low-speed printing.

It is another object of the present invention to provide a method for producing a pressure roller having such excellent properties.

Hitherto, it has been thought that a pressure roller needs to have elasticity, flexibility, and high adiabaticity in order to use the pressure roller in high-speed printing or full-color printing. It has been thought that the arrangement of a resin layer or a rubber layer having high heat conductivity to the pressure roller degrades adiabaticity to cause the transfer of heat from a fixing roller or fixing belt to the pressure roller, thus degrading fixation. It has been thought that the pressure roller needs to have high adiabaticity also in order to suppress an increase in temperature in the image-forming apparatus during operation.

The reason for a deterioration in fixation in high-speed printing is that an excessively high speed of a transfer material passing through the fixing unit results in the inefficient transfer of heat from the fixing roller or the fixing belt to an unfixed toner image of the transfer material. An increase in the temperature of the surface of the fixing roller or a heat source for the fixing belt does not meet the demands for low-temperature fixation and energy saving and results in a tendency to increase the temperature inside the image-forming apparatus during operation.

The inventors have believed that in high-speed printing or full-color printing, in order to increase the heat efficiency of the fixing unit to the unfixed toner image on the transfer material, a method of heating the transfer material also from the side of the back surface of the transfer material could be effective. However, the arrangement of a new heating means for heating the transfer material from the side of the back surface leads to the complexity and an increase in the size of the apparatus and does not meet energy saving, which is not practical.

Accordingly, the inventors have conceived a method of imparting a heat-accumulating function to the pressure roller that has been considered to be required to have excellent adiabaticity in order to improve fixation. Specifically, the inventors have conceived a method of arranging an intermediate rubber layer having high heat conductivity between a rubber layer containing organic microballoons and a heat-resistant resin layer of a pressure roller having a structure in which a roller base, the rubber layer, and the resin layer are arranged in that order.

The presence of the intermediate high-heat-conductivity rubber layer results in the accumulation of part of heat from the fixing roller or the fixing belt. The heat accumulated in the pressure roller is transferred to the transfer material from the side of the back surface of the transfer material. In this way, the transfer material is heated not only from the side of the front surface by heat from the fixing roller or the fixing belt but also from the side of the back surface by heat from the heat-accumulated pressure roller.

It has found that an increase in the temperature of the transfer material improves the fixation of the unfixed toner image thereon. That is, it has found that the incorporation of the above-described pressure roller into the fixing unit enables the unfixed toner image on the transfer material to be sufficiently fixed even with a high-speed printer having a printing speed of 30 sheets/min or more. Furthermore, in the case where heat is accumulated in the pressure roller, the accumulated heat is consumed during fixing due to high-speed printing; hence, the temperature inside the image-forming apparatus is not significantly increased. Heat from the pressure roller is transferred to the transfer material to increase the temperature of the transfer material. However, after the completion of the fixing step, the transfer material having the fixed toner image is ejected from the apparatus, thus suppressing the increase in temperature inside the image-forming apparatus.

The pressure roller of the present invention includes the intermediate high-heat-conductivity rubber layer between the rubber layer containing organic microballoons and the heat-resistant resin layer. Thus, the pressure roller has flexibility and uniform hardness and has excellent properties such as excellent elasticity, interlayer adhesion, heat resistance, mold-releasing properties, surface smoothness, and durability.

The fixing unit including the pressure roller of the present invention can be sufficiently used for high-speed printing and full-color printing as well as low-speed printing because the fixing unit has significantly improved heating efficiency. Heat accumulation in the pressure roller of the present invention is performed by utilizing part of heat from the fixing roller or the fixing belt, thus resulting in low costs and no increase in the complexity and size of the apparatus and satisfying the demand for energy saving.

In addition to the arrangement of the intermediate rubber layer having high heat conductivity to the pressure roller, the improvement of the heat conductivity of the heat-resistant resin layer (outermost layer) further improves heat efficiency thus further improving the suitability for high-speed printing and full-color printing. To increase the heat conductivity of the intermediate rubber layer and the heat-resistant resin layer, incorporating a heat-conductive filler into the material constituting each layer is effective.

A pressure roller of the present invention may be produced by a method including applying a heat-resistant resin material to the inner surface of a cylindrical metal mold to form a heat-resistant resin layer, applying a rubber material containing a heat-conductive filler onto the heat-resistant resin layer to form an intermediate rubber layer having high heat conductivity, inserting a roller base into the center of the axis of the cylindrical metal mold, injecting a rubber material containing organic microballoons into a gap between the roller base and the intermediate rubber layer, and performing vulcanization.

Another method for producing a pressure roller of the present invention includes forming a rubber layer containing organic microballoons on a roller base, continuously feeding a rubber composition containing a heat-conductive filler onto the surface of the rubber layer containing the organic microballoons from a dispenser provided with a feeding portion having a discharge port arranged at an end thereof while the roller base is rotated, wherein the rubber composition fed from the discharge port is helically applied to the surface of the rubber layer containing the organic microballoons by continuously moving the feeding portion of the dispenser in a direction along the axis of rotation of the roller base to form a rubber composition layer, and vulcanizing the rubber composition to form an intermediate rubber layer. The intermediate rubber layer is covered with a heat-resistant resin tube to form a heat-resistant resin layer.

In the fixing unit, heating the transfer material such as paper with the pressure roller having a heat-accumulating function from the back surface side of the transfer material as well as from the front surface side improves the heat efficiency and fixation in high-speed printing and full-color printing. This is based on a new idea. The use of the pressure roller having the heat-accumulating function improves the heat efficiency of the fixing unit and reduces electric power required for heating with the fixing unit. This is also based on a new idea.

These findings have led to the completion of the present invention.

The present invention provides a pressure roller including a rubber layer containing organic microballoons and a heat-resistant resin layer arranged in that order on a roller base, wherein an intermediate rubber layer having a heat conductivity of 1.0 to 4.0 W/m·K is arranged between the rubber layer containing the organic microballoons and the heat-resistant resin layer.

The present invention provides a method for producing the above-described pressure roller, the method including (1) a step 1 of applying a heat-resistant resin material to the inner surface of a cylindrical metal mold to form the heat-resistant resin layer, (2) a step 2 of applying a rubber composition containing a heat-conductive filler onto the heat-resistant resin layer and performing vulcanization to form the intermediate rubber layer, (3) a step 3 of inserting the roller base into the hollow interior of the cylindrical metal mold; and (4) a step 4 of injecting a rubber composition containing the organic microballoons into a gap between the roller base and the intermediate rubber layer and performing vulcanization to form the rubber layer containing the organic microballoons.

Furthermore, the present invention provides a method for producing the above-described pressure roller, the method including (I) a step I of forming the rubber layer containing the organic microballoons on the roller base, (II) a step II of continuously feeding a rubber composition containing a heat-conductive filler onto the surface of the rubber layer containing the organic microballoons from a dispenser provided with a feeding portion having a discharge port arranged at an end thereof while the roller base is rotated, wherein the rubber composition fed from the discharge port is helically applied to the surface of the rubber layer containing the organic microballoons by continuously moving the feeding portion of the dispenser in a direction along the axis of rotation of the roller base to form a rubber composition layer, and vulcanizing the rubber composition to form the intermediate rubber layer, and (III) a step III of covering the intermediate rubber layer with a heat-resistant resin tube.

### BRIEF DESCRIPTION OF THE DRAWINGS

FIG. 1 is a cross-sectional view of a layered structure of a pressure roller according to an embodiment of the present invention.

FIG. 2 is a process drawing of a method for producing a pressure roller according to an embodiment of the present invention.

FIG. 3 is a process drawing of a method for producing a pressure roller according to another embodiment of the present invention.

FIG. 4 is a cross-sectional view of a layered structure of a known pressure roller.

FIG. 5 is a cross-sectional view illustrating a fixing method with a fixing unit including a fixing roller and a pressure roller.

FIG. 6 is a cross-sectional view illustrating a fixing method with a fixing unit including a fixing belt and a pressure roller.

### BEST MODE FOR CARRYING OUT THE INVENTION

### 1. Pressure roller

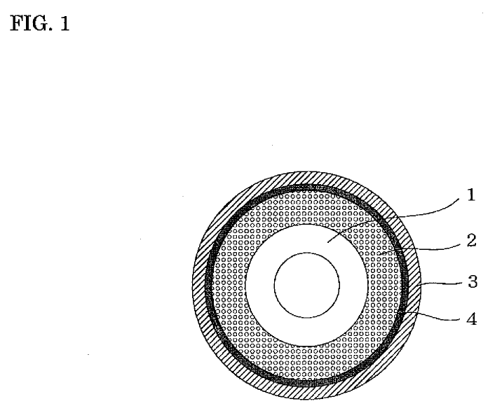

FIG. 1 is a cross-sectional view of a layered structure of a pressure roller according to an embodiment of the present invention. The pressure roller of the present invention has a layered structure in which a rubber layer 2 containing organic microballoons is arranged on a roller base 1, an intermediate rubber layer 4 having high heat conductivity is arranged on the rubber layer 2, and a heat-resistant resin layer 3 is arranged on the intermediate rubber layer 4, as shown in FIG. 1. In addition to the intermediate rubber layer having high heat conductivity, if necessary, another rubber layer or resin layer may be arranged between the rubber layer 2 containing organic microballoons and the heat-resistant resin layer 3 constituting the outermost layer The heat-resistant resin layer 3 may be a heat-resistant resin layer containing a conductive filler and having high heat conductivity.

The rubber layer 2 containing organic microballoons preferably has a thickness of 0.1 to 5 mm, more preferably 0.5 to 4 mm, and particularly preferably 1 to 3 mm. The intermediate rubber layer 4 preferably has a thickness of 10 to 500 μm, more preferably 20 to 400 μm, and particularly preferably 30 to 300 μm. The heat-resistant resin layer 3 preferably has a thickness of 1 to 100 μm, more preferably 5 to 50 μm, and particularly preferably 10 to 40 μm. The outside diameter of the roller base may be appropriately set in response to the size of the fixing unit and is preferably in the range of 10 to 40 mm and more preferably 12 to 30 mm. The length and the outside diameter of the pressure roller may be appropriately set in response to the size of the fixing unit including the pressure roller and the size of a transfer material.

### 2. Roller Base

The roller base used in the present invention is a cored bar or a tube. As the cored bar, in general, a cylinder or a column composed of a metal, such as aluminum, an aluminum alloy, iron, or stainless steel, or a ceramic material, such as alumina or silicon carbide, is used. As the tube, a heat-resistant resin tube or a metal tube is used.

As the roller base, a cylindrical or columnar cored bar widely used as a base of a pressure roller is preferred. The thickness, length, outside diameter, and the like of the roller base are set within common ranges and are not particularly limited. For example, the length of the roller base is appropriately determined in response to the size of the transfer material such as paper. The outside diameter of the roller base is preferably in the range of 10 to 40 mm and more preferably 12 to 30 mm.

### 3. Rubber Layer Containing Organic Microballoons

As a rubber material used for the rubber layer containing the organic microballoons, rubber, such as silicone rubber or fluorocarbon rubber, having excellent heat resistance is used. The term “heat-resistant rubber” refers to a rubber having heat resistance to the extent that the rubber withstands continuous use at a fixing temperature when a roller including the rubber layer is used as the pressure roller.

As the heat-resistant rubber, milable or liquid silicone rubber, fluorocarbon rubber, or a mixture thereof is preferred from the viewpoint of particularly excellent heat resistance. Specific examples thereof include silicone rubber, such as dimethyl silicone rubber, fluoro silicone rubber, methylphenyl silicone rubber, and vinyl silicone rubber; and fluorocarbon rubber, such as vinylidene fluoride rubber, tetrafluoroethylene-propylene rubber, tetrafluoroethylene-perfluoromethyl vinyl ether rubber, phosphazene-based fluorocarbon rubber, and fluoro polyether.

Among these, liquid silicone rubber is preferred from the viewpoint of the ease of the injection of liquid silicone rubber into a mold during the formation of the rubber layer. These rubbers may be used alone or in combination of two or more.

In the present invention, to impart flexibility to the rubber layer, the rubber layer contains the organic microballoons. The organic microballoons used in the present invention are hollow microspheres of some kind. For example, the organic microballoons are hollow spherical fine particles composed of a thermosetting resin such as a phenol resin, a thermoplastic resin such as polyvinylidene chloride or polystyrene, or an organic polymer material such as rubber. The organic microballoons each have a size of usually about 3 to 500 μm and mostly 5 to 200 μm.

In the present invention, a rubber-covered roller is used as a pressure roller in an image-forming apparatus and is continuously used or is used for a prolonged period. Thus, as the organic microballoons, heat-resistant organic microballoons composed of an organic polymer material having excellent heat resistance are preferably used. As the heat-resistant organic microballoons, hollow spherical fine particles composed of an organic polymer material having a decomposition kick-off temperature of 180° C. or higher are preferred. The term “decomposition kick-off temperature” defined here refers to a temperature at which a weight loss exceeding 5 percent by weight is observed when a sample is heated from room temperature at a heating rate of 20° C./min with a thermogravimetry unit.

The organic microballoons may be specially prepared, but a commercial item may be suitably used. The organic microballoons are spherical. Thus, if the organic microballoons are filled into a rubber material, stress anisotropy does not occur. Therefore, a rubber layer having uniform hardness can be formed. Even in the case where the organic microballoons are ruptured during the vulcanization of the rubber if the organic microballoons are left as bubbles, the bubbles can impart flexibility and adiabaticity to the rubber layer. From the viewpoint of the improvement of the flexibility and adiabaticity of the rubber layer and the vulcanization formability of the rubber layer, a rubber layer containing ruptured organic microballoons is often preferred. Thus, the present invention includes the rubber layer containing the ruptured organic microballoons. As such organic microballoons, hollow spherical fine particles having outer shells composed of a thermoplastic resin or an organic polymer material such as rubber are preferred.

The content of the organic microballoons in the rubber material is usually in the range of 5 to 60 percent by volume, preferably 10 to 50 percent by volume, and more preferably 15 to 45 percent by volume. The organic microballoons are spherical, and the proportion of the surface area to the volume is small. Thus, even when the organic microballoons are densely filled in the rubber material, the flowability of the rubber material can be satisfactorily maintained. An excessively low content of the organic microballoons results in insufficient flexibility of the rubber layer. An excessively high content of the organic microballoons may excessively increase the viscosity of the rubber material or may reduce the strength of the rubber layer.

From the viewpoint of flexibility, the hardness of the rubber layer containing the organic microballoons is preferably 20 or less in terms of ASKER C (Kobunshi Keiki) hardness. The lower limit of hardness is preferably 5° and mostly about 10°. The rubber layer containing the organic microballoons usually has a heat conductivity of 0.2 W/m·K or less and mostly 0.17 W/m·K or less. The lower limit of heat conductivity is usually 0.01 W/m·K and mostly 0.05 W/m·K.

If necessary, the rubber material may further contain an inorganic filler, such as carbon black, mica, or titanium oxide, or an organic filler such as natural resin. The content of the filler is usually 100 parts by weight or less and preferably 80 parts by weight or less with respect to 100 parts by weight of rubber.

The rubber layer containing the organic microballoons may further contain a free chlorine scavenger, a free acid scavenger, a free base scavenger, or a mixture of two or more these scavengers. As the resin material constituting the organic microballoons, polyvinylidene chloride, polyacrylonitrile, polymethacrylonitrile, a vinylidene chloride-acrylonitrile copolymer, or the like is used. These resin materials release a chlorine compound such as hydrogen chloride, an acid, a base, and the like in trace amounts by heating. The chlorine compound, the acid, the base, and the like easily degrade the rubber layer. Thus, the incorporation of the above-described scavenger results in the prevention of the deterioration of the rubber layer.

Examples of the scavenger include metallic soap, such as calcium stearate and magnesium stearate; inorganic acid salts such as hydrotalcite; organotin compounds such as butyltin dilaurate; and polyhydric alcohols, such as ethylene glycol, propylene glycoL and glycerin.

The content of the scavenger used is preferably in the range of 0.1 to 15 parts by weight and more preferably 0.5 to 10 parts by weight with respect to 100 parts by weight of the rubber material. The scavenger may be added to the rubber material independently of the organic microballoons. Alternatively, after surfaces of the organic microballoons are treated with the scavenger, the surface-treated organic microballoons may be added to the rubber material.

In the present invention, the rubber layer containing the organic microballoons preferably has a thickness of 0.1 to 5 mm, more preferably 0.5 to 4 mm, and particularly preferably 1 to 3 mm. In many cases, when the rubber layer containing the organic microballoons has a thickness of about 2 to 3 mm, particularly satisfactory performance can be exerted.

### 4. Intermediate Rubber Layer Having High Heat Conductivity

As a rubber material used for the intermediate rubber layer, preferably, rubber, such as silicone rubber or fluorocarbon rubber, having excellent heat resistance is used. The term “heat-resistant rubber” refers to a rubber having heat resistance to the extent that the rubber withstands continuous use at a fixing temperature when a rubber-covered roller including the intermediate rubber layer is used as the pressure roller.

As the heat-resistant rubber, milable or liquid silicone rubber, fluorocarbon rubber, or a mixture thereof is preferred from the viewpoint of particularly excellent heat resistance. Specific examples thereof include silicone rubber, such as dimethyl silicone rubber, fluoro silicone rubber, methylphenyl silicone rubber, and vinyl silicone rubber; and fluorocarbon rubber, such as vinylidene fluoride rubber, tetrafluoroethylene-propylene rubber, tetrafluoroethylene-perfluoromethyl vinyl ether rubber, phosphazene-based fluorocarbon rubber, and fluoro polyether. These maybe used alone or in combination of two or more. A mixture of silicone rubber and fluorocarbon rubber may be used.

Among these, liquid silicone rubber and fluorocarbon rubber are preferred because the intermediate rubber layer having high heat conductivity is easily formed by densely filling a heat-conductive filler therein. Examples of liquid silicone rubber include condensation-type liquid silicone rubber and addition-type liquid silicone rubber. Among these, addition-type liquid silicone rubber is preferred.

An addition-type liquid silicone rubber is formed by addition reaction of polysiloxane having vinyl groups and polysiloxane having Si—H bonds in the presence of a platinum catalyst to crosslink the siloxane chains. The curing rate can be desirably changed by changing the type or amount of platinum catalyst or by using a reaction inhibitor (retardant). A room-temperature curing type rubber is of two-component type and is readily curable at room temperature. A heat curing type rubber is curable at 100° C. to 200° C. by adjusting the amount of the platinum catalyst and using the reaction inhibitor. One-component heat curing type rubber (hereinafter, referred to as “one-component addition-type liquid silicone rubber”) is a mixture that is maintained at a liquid form during storage at a low temperature by enhancing inhibitory effects thereof and is cured by heating to form a rubbery state when used. Among these addition-type liquid silicone rubbers, a one-component addition-type liquid silicone rubber is preferred from the viewpoint of the ease of a mixing operation with the heat-conductive filler and a rubber-layer-forming operation and interlayer adhesion.

The intermediate rubber layer has a heat conductivity of 1.0 to 4.0 W/m·K, preferably 1.5 to 3.0 W/m·K, and more preferably 1.7 to 2.5 W/m·K. To increase the heat conductivity of the intermediate rubber layer, the intermediate rubber layer is preferably formed by a method for producing the intermediate rubber layer composed of a rubber composition containing a heat-conductive filler in at least one rubber selected from the group consisting of silicone rubber and fluorocarbon rubber. An excessively low heat conductivity of the intermediate rubber layer results in the insufficient effect of the pressure roller to accumulate heat from the fixing roller or the fixing belt, thus degrading the effect of improving the heat efficiency. Therefore, it is difficult to sufficiently improve fixation in high-speed printing or full-color printing. An excessively high heat conductivity of the intermediate rubber layer results in an excessively high content of the heat-conductive filler, thus possibly reducing the mechanical strength and interlayer adhesion of the intermediate rubber layer.

Examples of the heat-conductive filler include inorganic fillers having electrical insulating properties, e.g., silicon carbide (SiC), boron nitride (BN), alumina (Al₂O₃), aluminum nitride (AN), potassium titanate, mica, silica, titanium oxide, talc, and calcium carbonate. These heat-conductive fillers may be used alone or in combination of two or more.

Among these, silicon carbide, boron nitride, alumina, and aluminum nitride are preferred. From the viewpoint of excellent heat conductivity, stability, heat resistance, and the like, silicon carbide and boron nitride are more preferred. Silicon carbide has excellent heat conductivity and significantly high heat resistance. Boron nitride is in the form of a flat and has high heat conductivity and electrical insulating properties.

The heat-conductive filer usually has an average particle size of 0.5 to 15 μm and preferably 1 to 10 μm. The average particle size can be measured with a laser diffraction particle size distribution measuring apparatus (SALD-3000, manufactured by Shimadzu Corporation). An excessively small average particle size of the heat-conductive filler easily results in the insufficient effect of improving heat conductivity. An excessively large average particle size of the heat-conductive filler may result in irregularities on the surface of the intermediate rubber layer, thereby degrading the surface smoothness of the outermost layer (heat-resistant resin layer).

The content of the heat-conductive filler in the rubber composition is usually in the range of 5 to 60 percent by volume, preferably 8 to 50 percent by volume, and more preferably 10 to 45 percent by volume with respect to the total amount of the composition. An excessively low content of the heat-conductive filler results in difficulty in increasing the heat conductivity of the intermediate rubber layer. An excessively high content of the heat-conductive filler is liable to reduce the mechanical strength of the intermediate rubber layer.

The rubber composition containing the heat-conductive filler may be prepared by mixing the heat-conductive filler to a rubber material. According to need, a commercial item may be used. Examples of the commercial item include one-component addition-type liquid silicone rubbers (X32-2020, manufactured by Shin-Etsu Chemical Co., Ltd., and XE15-3261-G, manufactured by GE Toshiba Silicones Co., Ltd.) containing a heat-conductive filler such as silicon carbide (SiC).

The intermediate rubber layer preferably has a thickness of 10 to 500 μm, more preferably 20 to 400 μm, and particularly preferably 30 to 300 μm.

### 5. Heat-Resistant Resin Layer

The heat-resistant resin layer of the pressure roller of the present invention serves as the outermost layer (surface layer of the pressure roller) and preferably has excellent heat resistance, mold-releasing properties, and surface smoothness.

The heat-resistant resin used in the present invention is a high-heat-resistant synthetic resin that can be continuously used at 150° C. or higher and preferably 200° C. or higher in view of the case where the pressure roller is used in a high-temperature atmosphere. Examples of the heat-resistant resin include a fluororesin, polyimide, polyamide imide, polyether sulfone, polyether ketone, polybenzimidazole, polybenzoxazole, polyphenylene sulfide, and a bismaleimide resin.

Examples of the fluororesin include polytetrafluoroethylene (PTFE), a tetrafluoroethylene/perfluoroalkyl vinyl ether copolymer (PFA), a tetrafluoroethylene/hexafluoropropylene copolymer (FEP), an ethylene/tetrafluoroethylene copolymer (ETFE), polychlorotrifluoroethylene (PCTFE), an ethylene/chlorotrifluoroethylene copolymer (ECTFE), and polyvinylidene fluoride (PVDF).

These fluororesins may be used alone or in combination of two or more. For the outermost layer of the pressure roller, among these fluororesins, PTFE and PFA are preferred from the viewpoint of heat resistance and mold-releasing properties. PFA is more preferred because PFA has melt-flowability and because a fluororesin film having excellent surface smoothness is easily obtained. The fluororesin may be used as liquid fluororesin paint. From the viewpoint of the improvement of formability and mold-releasing properties, the fluororesin that is in the form of a powder (powdered paint) is preferably used. The average particle size of the fluororesin powder is not particularly limited but is preferably 10 μm or less in view of the formation of uniform thin film by powder coating. The lower limit is usually about 1 μm. In particular, PFA powder having an average particle size of 10 μm or less is preferably used.

Various powder coating methods may be employed to coat the fluororesin powder Among these, electrostatic coating (electrostatic powder spray coating) in which coating is performed by charging particles is preferably employed because a uniform, dense coating powder layer is formed on the inner surface of a cylindrical metal mold. After the formation of a fluororesin coating on the inner surface of the cylindrical metal mold, the fluororesin is sintered according to a common method. After sintering, the fluororesin coating preferably has a thickness of 1 to 100 μm, more preferably 5 to 50 μm, and particularly preferably 10 to 40 μm. To sufficiently exert the flexibility of the rubber layer, the thickness may be 30 μm or 20 μm or less.

A liquid fluororesin paint needs to contain a surfactant for dispersing fluororesin particles in a medium. In contrast, according to the method of coating the fluororesin powder, a pure fluororesin coating can be formed. This eliminates the presence of impurities in the fluororesin coating, the impirities being formed by carbonization of the surfactant after sintering. Thus, the fluororesin layer having excellent surface smoothness and mold-releasing properties can be formed.

In the case of the formation of a polyimide layer, polyimide varnish containing a polyimide precursor is applied to the inner surface of the cylindrical metal mold. After drying, dehydration and cyclization (imidization) are performed by heating. In the case where the heat-resistant resin is a thermoplastic resin, a solution thereof is applied and dried. The thickness of the heat-resistant resin layer is the same as that of the fluororesin layer.

To improve adhesion between the heat-resistant resin layer and the intermediate rubber layer, activation treatment of the heat-resistant resin layer formed on the inner surface of the cylindrical metal mold is preferably performed. Examples of the activation treatment of the heat-resistant resin layer include physical treatment by irradiation, such as ultraviolet irradiation with a UV lamp or an excimer lamp, corona discharge, plasma treatment, electron irradiation, ion irradiation, and laser irradiation; chemical treatment with metallic sodium; wet etching treatment with a treatment solution. For example, such an activation treatment results in the abstraction of fluorine atoms from the surface of the fluororesin coating or the hydrophilization of the surface of the heat-resistant resin layer, thereby increasing adhesion to the intermediate rubber layer. An adhesive suitable for the material of the intermediate rubber layer may be applied to the surface of the heat-resistant resin layer.

The intermediate rubber layer may be covered with the heat-resistant resin layer that is in the form of a tube. The rubber layer containing the organic microballoons is formed on the roller base. Then the intermediate rubber layer having high heat conductivity is formed on the rubber layer. The diameter of a heat-resistant resin tube is extended. The intermediate rubber layer is covered with the heat-resistant resin tube. The tube is heated to shrink. In the case where an adhesive is applied to the surface of the intermediate rubber layer and then the intermediate rubber layer is covered with the heat-resistant resin tube, the adhesion between the intermediate rubber layer and the heat-resistant resin tube can be increased.

The heat-resistant resin layer of the pressure roller of the present invention usually has a heat conductivity of 0.2 W/m·K or less. For example, a PAF layer composed of pure PFA has a heat conductivity of 0.19 W/m·K. The outermost layer of the pressure roller is required to have excellent heat resistance, mold-releasing properties, surface smoothness, and the like. Thus, a pure heat-resistant resin material not containing an inorganic filler or the like is usually used for the formation of the heat-resistant resin layer constituting the outermost layer. Therefore, in general, the heat-resistant resin layer has significantly low heat conductivity.

To further improve the heat conductivity from the surface of the pressure roller of the present invention, the heat-resistant resin layer may contain a heat-conductive filler. As a result, the heat-resistant resin layer preferably has a heat conductivity of 0.3 to 1.5 W/m·K, more preferably 0.4 to 1.0 W/m·K, and particularly preferably 0.5 to 0.9 W/m·K. By increasing the heat conductivity of the heat-resistant resin layer in addition to the intermediate rubber layer, heat from the fixing roller or the fixing belt can be efficiently transferred through the surface of the pressure roller and thus can be accumulated in the pressure roller. Furthermore, heat accumulated in the pressure roller can be efficiently transferred from the back side of a transfer material to the transfer material to increase heating efficiency, thereby improving fixation.

As the heat-conductive filler contained in the heat-resistant resin layer, the same filler as above described may be used. Exposure of the heat-conductive filler at the surface of the heat-resistant resin layer may degrade surface smoothness. A deterioration in the surface smoothness of the heat-resistant resin layer results in difficulty in uniform fixation or the deterioration of mold-releasing properties. To effectively prevent the exposure of the heat-conductive filler, a heat-resistant resin powder containing encapsulated heat-conductive filler formed by mixing the filler with the heat-resistant resin is preferably used.

As the heat-resistant resin layer, a thermal melting fluororesin such as PAF is often used. As a fluororesin powder, for example, a fluororesin powder preferably containing 10 to 40 percent by volume and more preferably 20 to 35 percent by volume of encapsulated heat-conductive filler such as silicon carbide or boron nitride is preferably used. For example, a commercially available PFA powder (trade name: MP623, manufactured by DuPont) is a resin powder in which a PFA powder (MP102 or MPP103, manufactured by DuPont) contains 20 to 35 percent by volume of silicon carbide. Each resin particle contains many silicon carbide fine particles that are not exposed at the surface. Thus, coating such a resin powder by powder coating results in the formation of heat-resistant resin layer having excellent heat conductivity and having the surface at which the heat-conductive filler is not exposed. The heat conductivity of the heat-resistant resin layer can be controlled by the use of a mixture of the heat-resistant resin powder containing the encapsulated heat-conductive filler and a heat-resistant resin powder not containing a heat-conductive filler.

An excessively low heat conductivity of the heat-resistant resin layer reduces a contribution to the improvement of the heat-accumulating effect of the pressure roller. An excessively high heat conductivity of the heat-resistant resin layer increases the content of the heat-conductive filler, thus degrading the mechanical strength and surface smoothness of the heat-resistant resin layer.

### 6. Method for Producing Pressure Roller

The pressure roller of the present invention may be produced by a method including the following steps 1 to 4:

(1) a step 1 of applying a heat-resistant resin material to the inner surface of a cylindrical metal mold to form a heat-resistant resin layer;

(2) a step 2 of applying a rubber composition containing a heat-conductive filler onto the heat-resistant resin layer and performing vulcanization to form an intermediate rubber layer;

(3) a step 3 of inserting a roller base into the hollow interior of the cylindrical metal mold; and

(4) a step 4 of injecting a rubber composition containing organic microballoons into a gap between the roller base and the intermediate rubber layer and performing vulcanization to form a rubber layer containing the organic microballoons.

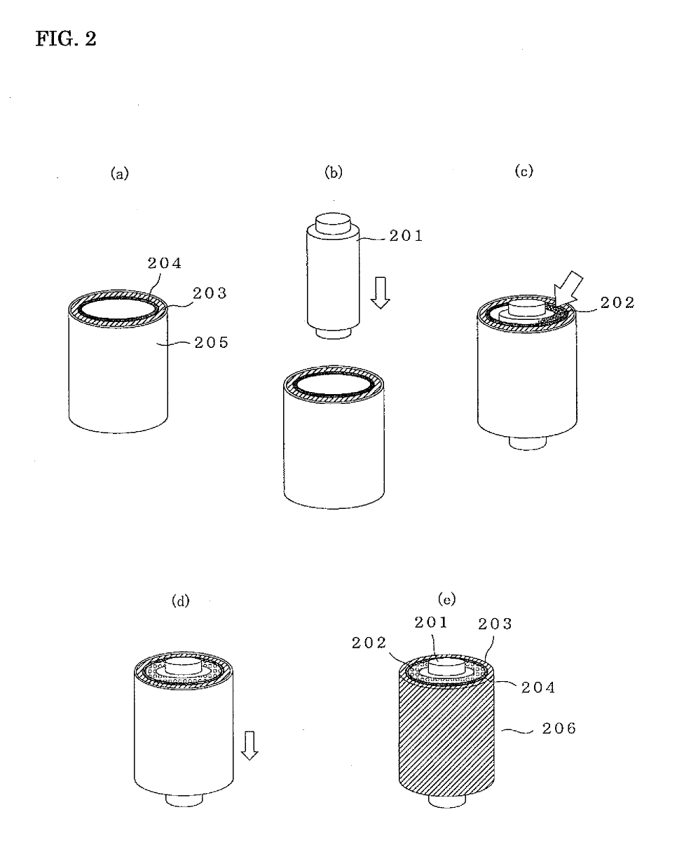

FIG. 2 is an explanatory drawing illustrating the production steps. In the step 1, the heat-resistant resin material is applied to the inner surface of the cylindrical metal mold to form the heat-resistant resin layer. That is, as shown in FIG. 2(a), the heat-resistant resin material is applied to the inner surface of the cylindrical metal mold 205 to form the heat-resistant resin layer 203.

For example, in the case where a fluororesin powder is used as the heat-resistant resin material, the fluororesin powder is coated on the inner surface of the cylindrical metal mold 205 and sintered to form a fluororesin coating. In the case where polyimide varnish is used as the heat-resistant resin material, polyimide varnish is applied to the inner surface of the cylindrical metal mold 205, dried, and heated to perform imidization, thereby forming a polyimide coating. For a thermoplastic resin, a solution of the thermoplastic resin is applied and dried to form a thermoplastic coating. After the formation of the heat-resistant resin layer, activation treatment of the surface of the heat-resistant resin layer may be performed, or an adhesive may be applied in order to improve adhesion to the intermediate rubber layer, according to need.

In the step 2, the rubber composition containing the heat-conductive filler is applied to the heat-resistant resin layer 203. Then vulcanization is performed to form the intermediate rubber layer 204 (FIG. 2(a)).

In the step 3, the roller base is inserted into the hollow interior of the cylindrical metal mold. As shown in FIG. 2(b), the roller base 201 is inserted into the hollow interior of the cylindrical metal mold 205 in which the heat-resistant resin layer 203 and the intermediate rubber layer 204 are formed in that order on the inner surface thereof. An adhesive may be applied to the surface of the roller base. The roller base 201 is set in such a manner that the center of the cylindrical metal mold 205 corresponds to the center of the roller base 201, i.e., in such a manner that both axes correspond to each other.

In the step 4, the rubber material containing the organic microballoons is injected into the gap between the roller base 201 and the intermediate rubber layer 204. Then vulcanization is performed to form the rubber layer 202 containing the organic microballoons. Specifically, as shown in FIG. 2(c), the unvulcanized rubber material containing the organic microballoons is injected into the gap between the intermediate rubber layer 204 and the roller base 201 and vulcanized to form the vulcanized rubber layer. The vulcanization conditions are selected in response to the type of rubber used. In the case of a liquid silicone rubber, vulcanization is performed by heating. The rubber material may be injected by an appropriate method, e.g., injection or extrusion. During the injection and vulcanization of the rubber material, an end or both ends of the cylindrical metal mold are usually sealed (not shown).

As shown in FIG. 2(d), after vulcanization of the rubber material containing the organic microballoons, the roller base 201 is removed from the cylindrical metal mold 205. As shown in FIG. 2(e), the removal of the cylindrical metal mold 205 results in the pressure roller 206 in which the rubber layer 202 containing the organic microballoons, the intermediate rubber layer 204 having high heat conductivity, and the heat-resistant resin layer 203 are formed in that order on the roller base 201.

The cylindrical metal mold used in the present invention is preferably composed of a metal such as iron, stainless steel, aluminum, or an aluminum alloy. However, the material of the cylindrical metal mold is not limited thereto as long as the material has a heat resistance so as to withstand the temperature during the sintering of the fluororesin and the heat-treatment temperature during the imidization of the polyimide precursor. Imparting satisfactory mold-releasing properties to the inner surface of the cylindrical metal mold facilitates removal of the pressure roller from the cylindrical metal mold in the final step.

To impart mold-releasing properties to the inner surface of the cylindrical metal mold, smoothing treatment is preferably performed. Examples of a method for subjecting the inner surface of the cylindrical metal mold to smoothing treatment include a method of using a drawn material when the cylindrical metal mold is composed of aluminum; and a method of performing surface treatment, e.g., chrome plating or nickel plating, when the cylindrical metal mold is composed of another material. The inner surface of the cylindrical metal mold preferably has a surface roughness (Rz) of 20 μm or less by smoothing treatment. More preferably, Rz is preferably 5 μm or less by horning or the like. Smoothing treatment of the inner surface of the cylindrical metal mold facilitates removal of the mold and results in the formation of heat-resistant resin layer having excellent surface smoothness.

The length of the cylindrical metal mold is the same as the length of the rubber coating layer of the pressure roller. The inner diameter of the mold is substantially specified by the sum of the outer diameter of the roller base and the thicknesses of the layers. The thickness of the cylindrical metal mold is appropriately determined in view of heat conduction during the sintering of the fluororesin, imidization of the polyimide precursor, vulcanization of rubber, and the like but is preferably in the range of about 1 to 10 mm. The outer shape of the cylindrical metal mold is not necessarily cylindrical. The cylindrical metal mold may have a cylindrical inner surface.

According to the above production method, the intermediate rubber layer and the rubber layer containing the organic microballoons are not exposed to high temperatures required for the sintering of the fluororesin and the imidization of the polyimide precursor, thus preventing the thermal degradation of the rubber layers. Furthermore, according to the method, steps of grinding surfaces of the rubber layers may be omitted.

The fixing roller may also be produced by another method including the following steps I to III:

(I) a step I of forming a rubber layer containing organic microballoons on a roller base;

(II) a step II of continuously feeding a rubber composition containing a heat-conductive filler onto the surface of the rubber layer containing the organic microballoons from a dispenser provided with a feeding portion having a discharge port arranged at an end thereof while the roller base is rotated, wherein the rubber composition fed from the discharge port is helically applied to the surface of the rubber layer containing the organic microballoons by continuously moving the feeding portion of the dispenser in a direction along the axis of rotation of the roller base to form a rubber composition layer, and vulcanizing the rubber composition to form an intermediate rubber layer; and

(III) a step III of covering the intermediate rubber layer with a heat-resistant resin tube.

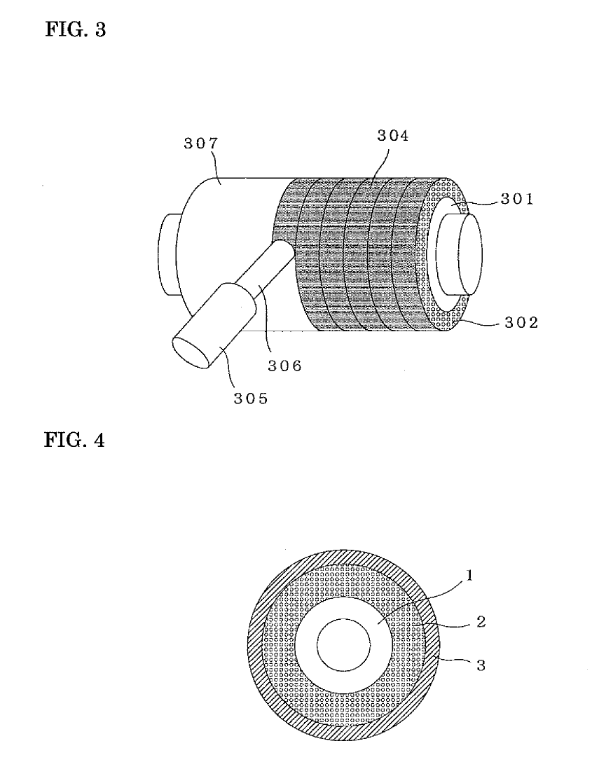

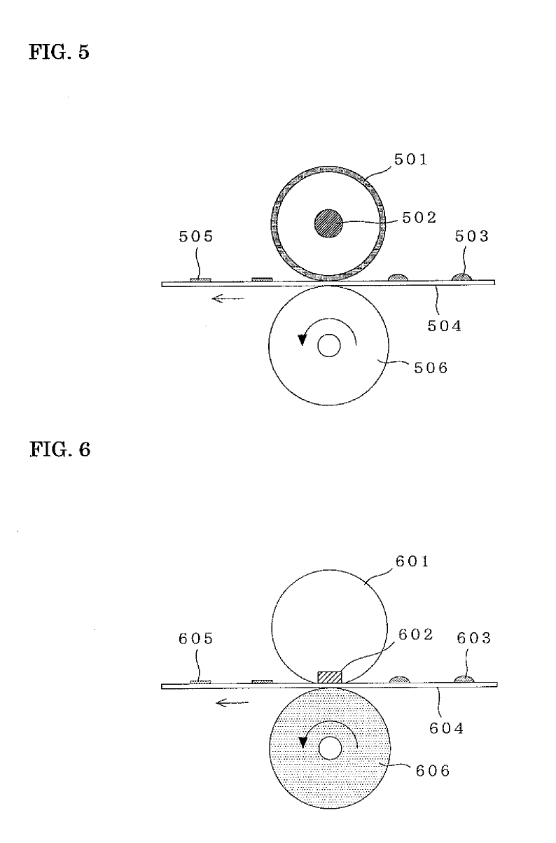

The production method will be described below with reference to FIG. 3. In the step I, the rubber layer 302 containing the organic microballoons is formed on the roller base 301. The rubber layer 302 containing the organic microballoons may be formed by a method including inserting the roller base 301 into a cylindrical metal mold in such a manner that centers of axes correspond, injecting a rubber material containing the organic microballoons into a gap between the inner surface of the cylindrical metal mold and the roller base, and performing vulcanization. Alternatively, the rubber layer 302 containing the organic microballoons may be formed by a method including covering the periphery of the roller base 301 with the rubber material containing the organic microballoons, performing vulcanization, and grinding the surface.

In the step II, the rubber composition containing the heat-conductive filler is continuously fed onto the surface 307 of the rubber layer 302 containing the organic microballoons from the dispenser provided with the feeding portion 305 having the discharge port 306 arranged at the end thereof while the roller base is rotated, wherein the rubber composition fed from the discharge port 306 is helically applied to the surface 307 of the rubber layer containing the organic microballoons by continuously moving the feeding portion 305 of the dispenser in a direction along the axis of rotation of the roller base 301 to form the rubber composition layer 304. Then the rubber composition is vulcanized to form the intermediate rubber layer.

As the rubber material constituting the intermediate rubber layer, liquid silicone rubber and fluorocarbon rubber are preferred, and liquid silicone rubber is more preferred. As the liquid silicone rubber, addition-type liquid silicone rubber is preferred, and one-component addition-type liquid silicone rubber is more preferred. To form a uniform coating layer with the dispenser, the rubber composition containing the heat-conductive filler is preferably in the form of a liquid at room temperature and preferably has a viscosity (25° C.) of 1 to 1,500 Pa·s and more preferably 5 to 1,000 Pa·s. An excessively low viscosity of the rubber composition is liable to cause dripping during application or drying. An excessively high viscosity reduces the thickness of a portion where turns of the rubber composition layer helically formed are in contact with each other compared with thicknesses of other portions, thereby resulting in difficulty in forming the intermediate rubber layer having a uniform thickness.

In the case where a material, such as boron nitride, that is in the form of flat (scale) particles is used as the heat-conductive filler, the flat particles are aligned in the circumferential direction. Thus, the intermediate rubber layer having high strength in the circumferential direction of the intermediate rubber layer can be formed.

As the feeding portion 305 having the discharge port 306, a nozzle is usually used. Preferably, the oblique end of the nozzle is formed so that the central portion of the discharge port 306 can be continuously moved in a direction along the axis of rotation of the roller base 301 while being in contact with the surface 307 of the rubber layer 302 containing the organic microballoons. As the feeding portion 305, a plastic nozzle, a rubber nozzle, a metallic nozzle, or the like may be used. A nozzle made of a fluororesin such as PTFE or PFA is preferably used because the nozzle has proper stiffness and does not easily scratch the surface 307 of the rubber layer 302 containing the organic microballoons. The thickness of the nozzle is preferably in the range of 0.3 to 3.0 mm.

In order that the turns of the liquid rubber composition helically applied in the form of a strip come into contact with each other to form a coating layer having a uniform thickness, the moving speed of the dispenser and the rotation speed of the roller base 301 are controlled to apply the liquid rubber composition to the surface 307 of the rubber layer 302 containing the organic microballoons without a gap. Let the moving speed of the feeding portion of the dispenser be V (mm/s). The ratio of the moving speed to the rotation speed R (rotation/s) of the roller base is usually 3.0 or less, preferably 2.5 or less, more preferably 2.2 or less, and particularly preferably 1.5 or less.

After the formation of the coating layer of the rubber composition containing the electrically conductive filler, usually, heat treatment is performed to vulcanize the rubber composition. The rubber composition layer (intermediate rubber layer) preferably has a thickness of 10 to 500 μm, more preferably 20 to 400 μm, and particularly preferably 30 to 300 μm.

In the step III, the intermediate rubber layer is covered with the heat-resistant resin tube. As the heat-resistant resin tube, usually, a fluororesin tube is used. Examples of the material of the fluororesin tube include PTFE, PFA, FEP, ETFE, PCTF, ECTFE, and PVDF. Among these, PFA is preferred from the viewpoint of excellent heat resistance, mold-releasing properties (nonadherent), durability, formability, and the like. A fluororesin tube formed by melt-extruding a fluororesin into a tube may be used. As the fluororesin tube, a fluororesin coating formed by applying fluororesin paint and preferably a fluororesin powder to the inner surface of the cylindrical metal mold and sintering the coating may also be used.

The fluororesin tube preferably has a thickness of 5 to 50 μm and more preferably 10 to 40 μm. The inner surface of the fluororesin tube is subjected to wet etching with a naphthalene complex of metallic sodium or dry etching by corona discharge, thereby improving adhesion.

The fluororesin tube may be brought into intimate contact with the intermediate rubber layer by a method as follows: An adhesive is applied to the inner surface of the fluororesin tube having an inner diameter smaller than the outer diameter of the intermediate rubber layer or to the surface of the intermediate rubber layer. Then the inner diameter of the fluororesin tube is expanded in such a manner that the tube has an inner diameter larger than the outer diameter of the intermediate rubber layer. The intermediate rubber layer is covered with the tube. Heat treatment is performed at 130° C. to 200° C. for 15 minutes to 3 hours to reduce the diameter of the fluororesin tube. A sample having a size of 10 cm×10 cm and obtained by cutting out the fluororesin tube having an expanded diameter preferably has a thermal shrinkage of 5% to 10% (in a constant temperature oven at 150° C. for 30 minutes).

### 7. Advantages

In the present invention, in a pressure roller including a rubber layer containing organic microballoons and a heat-resistant resin layer arranged in that order on a roller base, an intermediate rubber layer having a heat conductivity of 1.0 to 4.0 W/m·K is arranged between the rubber layer containing the organic microballoons and the heat-resistant resin layer. Thereby, a heat-accumulating function is imparted to the pressure roller.

After the power to the image-forming apparatus is turned on, in the fixing unit, part of heat from the fixing roller or the fixing belt is accumulated on the pressure roller side. This is evident from the fact that the temperature of a transfer material (e.g., transfer paper) passing through the fixing unit is usually 10° C. or more, preferably 15° C. or more, and more preferably 20° C. or more higher than that of a pressure roller not including a heat-conductive intermediate rubber layer. In the case where the pressure roller of the present invention is used, in many cases, the temperature of the transfer material passing through the fixing unit is increased to about 30° C. or about 35° C. compared with the case where a known pressure roller is used. That is, the fixing unit including the pressure roller of the present invention can heat the transfer material not only from the front side but also from the back side and has significantly improved heating efficiency.

The improvement of heat efficiency is also observed in high-speed printing. Thus, the fixing unit including the pressure roller of the present invention can be sufficiently used in high-speed printing. Furthermore, the fixing unit including the pressure roller of the present invention exhibits excellent fixation in full-color printing. The pressure roller of the present invention has the heat-accumulating function, thereby eliminating the need for a special heating means and sufficiently contributing to a reduction in the size of the apparatus and energy saving.

In the pressure roller of the present invention, heat conductivity is imparted to the heat-resistant resin layer serving as the outermost layer as well as the intermediate rubber layer without a deterioration in surface smoothness. Thus, the pressure roller has the further improved heat-accumulating function and heating efficiency.

The fixing unit including the pressure roller of the present invention heats the transfer material from both front and back sides to fix an image, and then the transfer material having the fixed image is ejected from the image-forming apparatus, thus reducing a disadvantageous increase in temperature inside the apparatus. In the case where the fixing unit including the pressure roller of the present invention is arranged in an electrophotographic copier capable of performing high-speed printing, the disadvantageous increase in temperature inside the copier is further reduced.

The pressure roller of the present invention includes the rubber layer containing the organic microballoons arranged on the roller base and the heat-resistant resin layer arranged as the outermost layer and thus has excellent elasticity, flexibility, heat resistance, mold-releasing properties, surface smoothness, and durability.

### EXAMPLES

The present invention will be described in more detail below by way of examples and comparative example. Methods measurement and evaluation methods of physical properties and characteristics are as follows.

### (1) Heat Conductivity

Heat conductivities of layers were measured with a quick thermal conductivity meter QTM-D3, manufactured by Kyoto Electronics Manufacturing Co., Ltd.

### (2) Fixation

A pressure roller produced in each of examples and comparative example was incorporated in the fixing unit of a commercially available electrophotographic copier. A fixing roller arranged opposite the pressure roller was a coated roller member in which a silicone rubber layer having a thickness of 2 mm and a fluororesin layer having a thickness of 20 μm were laminated in that order on a cylindrical aluminum cored bar. The surface temperature of the fluororesin layer of the fixing roller was set at 180° C. with a halogen lamp heater arranged in the fixing roller. As the electrophotographic copier, two models were used: a 15-sheet model (printing speed: 15 sheets/min) and a 30-sheet model (printing speed: 30 sheets/min).

Unfixed toner images composed of black toner were formed. The unfixed toner images were passed through the fixing unit and pressurized at a nip width of 3 mm. Continuous printing of 50,000 sheets was performed. Fixation was evaluated on the basis of the following criteria:

A: No offset phenomenon in which a fixed image is distorted or stained is observed after continuous printing of 50,000 sheets.
B: The offset phenomenon is slightly observed after continuous printing of 30,000 sheets.
C: The offset phenomenon is clearly observed after continuous printing of 1,000 sheets.

### (3) Temperature of Transfer Paper

Continuous printing of 100 sheets was performed with each of the two types of electrophotographic copiers. The temperature of the 100th transfer paper on which a fixed image was formed was rapidly measured with a temperature measurement apparatus (IT2-80, manufactured by Keyence Corporation).

### (4) Durability

A continuous printing test of 50,000 sheets was performed with the electrophotographic copier (30-sheet model). Durability was evaluated on the basis of the following criteria.

A: There is no abnormality of the pressure roller.
B: The offset phenomenon occurs, or the transfer paper is creased.
C: The pressure roller is cracked in the surface.

### Example 1

According to the production method shown in FIG. 2, a pressure roller including a rubber layer containing organic microballoons, a heat-conductive intermediate rubber layer, and a fluororesin layer (heat-resistant resin layer) arranged in that order on a roller base was produced.

### (1) Formation of Fluororesin Layer

The inner surface of a cylindrical aluminum metal mold having an inner diameter of 24 mm and a length of 300 mm was chrome plated. A PFA powder (MP-102, manufactured by DuPont) was applied to the plated surface (surface roughness: 20 μm or less) by powder coating. The resulting coating was heat-treated at 380° C. for 30 minutes to form a fluororesin coating having a thickness of about 20 μm. The fluororesin coating had a heat conductivity of 0.19 W/m·K.

Etching was performed by applying TETRA-ETCHU (manufactured by Junkosha Inc.) to the surface of the fluororesin coating and rinsing the surface with water.

(2) Formation of Intermediate Rubber Layer

A one-component addition-type liquid silicone rubber containing a heat-conductive filler (X32-2020, manufactured by Shin-Etsu Chemical Co., Ltd.) was applied to the surface of the fluororesin coating and vulcanized by heating at 160° C. for 15 minutes. Thereby, an intermediate rubber layer having a thickness of 100 μm and a heat conductivity of 1.9 W/m·K was formed.

### (3) Formation of Organic-Microballoon-Containing Rubber

A primer (DY39-012, manufactured by Dow Corning Toray Co., Ltd.) was applied to the surface of a cored bar (columnar roller base) composed of aluminum and having an outer diameter of 20 mm and a length of 300 mm and air-dried. The cored bar was inserted into the hollow interior of the cylindrical metal mold including the fluororesin coating and the intermediate rubber layer in such a manner that both centers of axes correspond.

A rubber material containing a liquid silicone rubber (KE1380, manufactured by Shin-Etsu Chemical Co., Ltd.), 40 percent by volume (with respect to the total amount) of vinylidene chloride acrylonitrile copolymer microballoons (manufactured by Matsumoto Yushi-Seiyaku Co., Ltd.), and 5 parts by weight of glycerin (proportion with respect to 100 parts by weight of the liquid silicone rubber) was fed into a gap between the intermediate rubber layer and the cored bar and hot-vulcanized at 160° C. for 15 minutes. The resulting rubber layer had a heat conductivity of 0.15 W/m·K.

### (4) Removal of Mold

Next, the mold was removed to obtain a coated roller. The coated roller had no crease, breakage, waviness, or irregularities of the surface. This coated roller was used as the pressure roller. The physical properties and characteristics were evaluated. Table shows the results.

### Comparative Example

### (1) Formation of Fluororesin Layer

The inner surface of a cylindrical aluminum metal mold having an inner diameter of 24 mm and a length of 300 mm was chrome plated. A PFA powder (MP-102, manufactured by DuPont) was applied to the plated surface (surface roughness: 20 μm or less) by powder coating. The resulting coating was heat-treated at 380° C. for 30 minutes to form a fluororesin coating having a thickness of about 20 μm. The fluororesin coating had a heat conductivity of 0.19 W/m·K.

Etching was performed by applying TETRA-ETCH® (manufactured by Junkosha Inc.) to the surface of the fluororesin coating and rinsing the surface with water. A primer (DY39-012, manufactured by Dow Corning Toray Co., Ltd.) was applied to the etched surface of the fluororesin coating and air-dried.

### (2) Formation of Organic-Microballoon-Containing Rubber

The same primer as above was applied to the surface of a cored bar composed of aluminum and having an outer diameter of 20 mm and a length of 300 mm and air-dried. Then the cored bar was inserted into the hollow interior of the cylindrical metal mold including the fluororesin coating in such a manner that both centers of axes correspond.

A rubber material containing a liquid silicone rubber (KE1380, manufactured by Shin-Etsu Chemical Co., Ltd.), 40 percent by volume (with respect to the total amount) of vinylidene chloride acrylonitrile copolymer microballoons (manufactured by Matsumoto Yushi-Seiyaku Co., Ltd.), and 5 parts by weight of glycerin (proportion with respect to 100 parts by weight of the liquid silicone rubber) was fed into a gap between the iluororesin coating and the cored bar and hot-vulcanized at 160° C. for 15 minutes. The resulting rubber layer had a heat conductivity of 0.15 W/m·K.

### (3) Removal of Mold

Next, the mold was removed to obtain a coated roller. The coated roller had no crease, breakage, waviness, or irregularities of the surface. This coated roller was used as the pressure roller. The physical properties and characteristics were evaluated. Table shows the results.

### Example 2

(1) Formation of Heat-Resistant Resin Layer Having Heat Conductivity

The inner surface of a cylindrical aluminum metal mold having an inner diameter of 24 mm and a length of 300 mm was chrome plated. A fluororesin powder (MP623, manufactured by DuPont) in which encapsulated silicon carbide was formed by mixing 30 percent by volume of silicon carbide into a PFA powder (MP-102, manufactured by DuPont) was applied to the inner surface by powder coating. The resulting coating was heat-treated at 380° C. for 30 minutes to form a fluororesin coating having a thickness of about 20 μm. The fluororesin coating had a heat conductivity of 0.63 W/m·K.

Etching was performed by applying TETRA-ETCH® (manufactured by Junkosha Inc.) to the surface of the fluororesin coating and rinsing the surface with water.

### (2) Formation of Intermediate Rubber Layer

A one-component addition-type liquid silicone rubber containing a heat-conductive filler (X32-2020, manufactured by Shin-Etsu Chemical Co., Ltd.) was applied to the surface of the fluororesin coating and vulcanized by heating at 160° C. for 15 minutes. Thereby, an intermediate rubber layer having a thickness of 100 μm and a heat conductivity of 1.9 W/m·K was formed.

### (3) Formation of Organic-Microballoon-Containing Rubber

A primer (DY39-012, manufactured by Dow Corning Toray Co., Ltd.) was applied to the surface of a cored bar (columnar roller base) composed of aluminum and having an outer diameter of 20 mm and a length of 300 mm and air-dried. The cored bar was inserted into the hollow interior of the cylindrical metal mold including the fluororesin coating and the intermediate rubber layer in such a manner that both centers of axes correspond.

A rubber material containing a liquid silicone rubber (KE1380, manufactured by Shin-Etsu Chemical Co., Ltd.), 40 percent by volume (with respect to the total amount) of vinylidene chloride acrylonitrile copolymer microballoons (manufactured by Matsumoto Yushi-Seiyaku Co., Ltd.), and 5 parts by weight of glycerin (proportion with respect to 100 parts by weight of the liquid silicone rubber) was fed into a gap between the intermediate rubber layer and the cored bar and hot-vulcanized at 160° C. for 15 minutes. The resulting rubber layer had a heat conductivity of 0.15 W/m·K.

### (4) Removal of Mold

Next, the mold was removed to obtain a coated roller. The coated roller had no crease, breakage, waviness, or irregularities of the surface. This coated roller was used as the pressure roller. The physical properties and characteristics were evaluated. Table shows the results.

TABLE

| | | Comparative | |
|---|---|---|---|
| | Example 1 | example 1 | Example 2 |
| Heat-resistant | Pure PFA | Pure PFA | Heat-conductive- |
| resin | | | filler-containing |
| | | | PFA |
| Heat conductivity | 0.19 | 0.19 | 0.63 |
| [W/m · K] | | | |
| Intermediate | Heat-conductive- | None | Heat-conductive- |
| rubber layer | filler-containing | | filler-containing |
| | silicone rubber | | silicone rubber |
| Heat conductivity | 1.9 | — | 1.9 |
| [W/m · K] | | | |
| Rubber layer | Silicone rubber | Silicone rubber | Silicone rubber |
| Microballoon | 40 | 40 | 40 |
| (vol %) | | | |
| Heat conductivity | 0.15 | 0.15 | 0.15 |
| [W/m · K] | | | |
| Fixation | | | |
| 15-Sheet model | A | A | A |
| 30-Sheet model | A | C | A |
| Temperature of | | | |
| transfer paper | | | |
| (° C.) | | | |
| 15-Sheet model | 110 | 80 | 115 |
| 30-Sheet model | 110 | 70 | 105 |
| Durability | A | B | A |

### Example 3

### (100) Formation of Organic-Microballoon-Containing Rubber

The inner surface of a cylindrical aluminum metal mold having an inner diameter of 23 mm and a length of 300 mm was chrome plated. A primer (DY39-012, manufactured by Dow Corning Toray Co., Ltd.) was applied to the surface of a cored bar (columnar roller base) composed of aluminum and having an outer diameter of 20 mm and a length of 300 mm and air-dried. The cored bar was inserted into the hollow interior of the cylindrical metal mold including the fluororesin coating and the intermediate rubber layer in such a manner that both centers of axes correspond.

A rubber material containing a liquid silicone rubber (KE1380, manufactured by Shin-Etsu Chemical Co., Ltd.), 40 percent by volume (with respect to the total amount) of vinylidene chloride acrylonitrile copolymer microballoons (manufactured by Matsumoto Yushi-Seiyaku Co., Ltd.), and 5 parts by weight of glycerin (proportion with respect to 100 parts by weight of the liquid silicone rubber) was fed into a gap between the intermediate rubber layer and the cored bar and hot-vulcanized at 160° C. for 15 minutes. The resulting rubber layer had a heat conductivity of 0.15 W/m·K.

### (2) Formation of Intermediate Rubber Layer

A one-component addition-type liquid silicone rubber containing a heat-conductive filler (X32-2020, manufactured by Shin-Etsu Chemical Co., Ltd.) was discharged to the surface of the rubber layer from the nozzle of a dispenser while the cored bar was rotated at a rotation speed of one rotation per second. The nozzle of the dispenser was moved at a moving speed of 1.1 mm/s in a direction of the axis of rotation of the cored bar. Thereby, the liquid rubber composition was helically applied to the surface of the rubber layer on the cored bar to form a coating layer having a uniform thickness. The coating layer was heated at 150° C. for 30 minutes and vulcanized. Thereby, an intermediate rubber layer having a thickness of 100 μm and a heat conductivity of 1.9 W/m·K was formed.

(3) Covering with Heat-Resistant Resin Tube

The inner surface of a PFA tube (thickness: 30 μm, inner diameter: 22 mm, PFA having fluorine-terminated molecular chains was used) formed by melt-extrusion was etched with a naphthalene complex of metallic sodium and rinsed with water. Then an adhesive (primer 101, manufactured by Shin-Etsu Chemical Co., Ltd.) was applied to the inner surface of the tube and allowed to stand at room temperature for 30 minutes to dry the adhesive.

The diameter of the PEA tube was expanded to have an inner diameter of 23.5 mm. The intermediate rubber layer was covered with the expanded PFA tube and heated at 200° C. for 1 hour to obtain a coated roller being in close contact with the PFA tube. When the coated roller was used as the pressure roller, the same results as in Example 1 were obtained.

### INDUSTRIAL APPLICABILITY

A pressure roller of the present invention can be used as a pressure roller included in a fixing unit of an image-forming apparatus utilizing an electrophotographic method. The pressure roller of the present invention has a flexible rubber layer with uniform hardness. The pressure roller of the present invention has excellent flexibility, interlayer adhesion, heat resistance, mold-releasing properties, surface smoothness, durability, and the like. Furthermore, pressure roller of the present invention can be sufficiently used in high-speed printing and full-color printing as well as low-speed printing.

1. A pressure roller comprising a rubber layer containing organic microballoons and a heat-resistant resin layer arranged in that order on a roller base, wherein an intermediate rubber layer having a heat conductivity of 1.0 to 4.0 W/m·K is arranged between the rubber layer containing the organic microballoons and the heat-resistant resin layer.

2. The pressure roller according to claim 1, wherein the intermediate rubber layer is composed of a rubber composition containing a heat-conductive filler and at least one rubber selected from the group consisting of silicone rubber and fluorocarbon rubber.

3. The pressure roller according to claim 2, wherein the heat-conductive filler is at least one inorganic filler selected from the group consisting of silicon carbide, boron nitride, alumina, aluminum nitride, potassium titanate, mica, silica, titanium oxide, talc, and calcium carbonate.

4. The pressure roller according to claim 2, wherein the content of the heat-conductive filler in the rubber composition is in the range of 5 to 60 percent by volume.

5. The pressure roller according to claim 1, wherein the intermediate rubber layer has a heat conductivity of 1.5 to 3.0 W/m·K.

6. The pressure roller according to claim 1, wherein the intermediate rubber layer has a thickness of 30 to 300 μm.

7. The pressure roller according to claim 1, wherein the heat-resistant resin layer is a fluororesin layer or a polyimide layer.

8. The pressure roller according to claim 7, wherein the fluororesin is polytetrafluoroethylene (PTFE) or a tetrafluoroethylene/perfluoroalkyl vinyl ether copolymer (PFA).

9. The pressure roller according to claim 1, wherein the heat-resistant resin layer has a heat conductivity of 0.2 W/m·K or less.

10. The pressure roller according to claim 1, wherein the heat-resistant resin layer is composed of a heat-resistant resin composition containing a heat-resistant resin and a heat-conductive filler, and the heat-resistant resin layer has a heat conductivity of 0.3 to 1.5 W/m·K.

11. The pressure roller according to claim 10, wherein the heat-resistant resin composition is a heat-resistant resin powder in which the heat-resistant resin contains the encapsulated heat-conductive filler.

12. The pressure roller according to claim 1, wherein the heat-resistant resin layer has a thickness of 5 to 50 μm.

13. The pressure roller according to claim 1, wherein the rubber layer containing the organic microballoons has a heat conductivity of 0.2 W/m·K or less.

14. The pressure roller according to claim 1, wherein the organic microballoons are hollow spherical fine particles composed of at least one organic polymer material selected from the group consisting of thermoplastic resins, thermosetting resins, and rubber.

15. The pressure roller according to claim 14, wherein the organic polymer material is a thermosetting resin having a decomposition kick-off temperature of 180° C. or higher.

16. The pressure roller according to claim 1, wherein the rubber layer containing the organic microballoons is composed of a rubber composition, the rubber composition containing the organic microballoons and at least one rubber selected from the group consisting of silicone rubber and fluorocarbon rubber

17. The pressure roller according to claim 16, wherein the content of the organic microballoons in the rubber composition is in the range of 5 to 60 percent by volume.

18. The pressure roller according to claim 1, wherein the rubber layer containing the organic microballoons has a thickness of 0.1 to 5 mm.

19. A method for producing the pressure roller according to claim 1, the method comprising:
(1) a step 1 of applying a heat-resistant resin material to the inner surface of a cylindrical metal mold to form the heat-resistant resin layer;
(2) a step 2 of applying a rubber composition containing a heat-conductive filler onto the heat-resistant resin layer and performing vulcanization to form the intermediate rubber layer;
(3) a step 3 of inserting the roller base into the hollow interior of the cylindrical metal mold; and
(4) a step 4 of injecting a rubber composition containing the organic microballoons into a gap between the roller base and the intermediate rubber layer and performing vulcanization to form the rubber layer containing the organic microballoons.

20. A method for producing the pressure roller according to claim 1, the method comprising:
(I) a step I of forming the rubber layer containing the organic microballoons on the roller base;
(II) a step II of continuously feeding a rubber composition containing a heat-conductive filler onto the surface of the rubber layer containing the organic microballoons from a dispenser provided with a feeding portion having a discharge port arranged at an end thereof while the roller base is rotated, wherein the rubber composition fed from the discharge port is helically applied to the surface of the rubber layer containing the organic microballoons by continuously moving the feeding portion of the dispenser in a direction along the axis of rotation of the roller base to form a rubber composition layer, and vulcanizing the rubber composition to form the intermediate rubber layer; and
(III) a step III of covering the intermediate rubber layer with a heat-resistant resin tube.
